(19) United States
(12) Patent Application Publication
(10) Pub. No.: US 2010/0095768 A1
(43) Pub. Date: Apr. 22, 2010

(54) Micromachined torsional gyroscope with anti-phase linear sense transduction

(75) Inventors: Cenk Acar, Irvine, CA (US); Minyao Mao, Santa Rosa, CA (US)

Correspondence Address: EDWARD S. WRIGHT, 1100 ALMA STREET, SUITE 207, MENLO PARK, CA, 94025, US

(73) Assignee: CUSTOM SENSORS & TECHNOLOGIES, INC., Moorpark, CA (US)

(21) Appl. No.: 12/254,223

(22) Filed: Oct. 20, 2008

(51) Int. Cl. G01C 19/56

(52) U.S. Cl. 73/504.04

(57) ABSTRACT

Micromachined gyroscope having a pair of masses disposed generally in a plane and driven for out-of-plane torsional oscillation about a pair of drive axes in the plane for sensing rotation about an input axis perpendicular to the drive axes. The masses are mounted for in-plane torsional movement about sense axes perpendicular to the drive axes and the input axis in response to Coriolis forces produced by rotation of the masses about the input axis. A link connects the two masses together for movement of equal amplitude and opposite phase both about the drive axes and about the sense axes. The masses are connected to transducers having input electrodes constrained for linear in-plane movement relative to stationary electrodes, with that torsional movement of the masses about the sense axes producing changes in capacitance between the input electrodes and the stationary electrodes.

### BACKGROUND OF THE INVENTION

1. Field of Invention

This invention relates generally to inertial sensors and, more particularly, to an angular rate sensor, or gyroscope, which is relatively immune to external vibration and acceleration.

2. Related Art

Angular rate sensors, or gyroscopes, typically rely on the detection of sinusoidal Coriolis responses with extremely small amplitudes in the sense mode and are susceptible to extraneous responses due to external vibration. Heretofore, some attempts have been made to minimize the effects of vibration through the use of systems such as tuning fork architectures that are designed to cancel common-mode inputs. However, most anti-phase systems can not completely cancel out the mechanical response due to vibration, primarily because of mechanical imbalances, e.g. imbalances in mass and/or stiffness, and electrical imbalances between the components of the anti-phase systems.

### OBJECTS AND SUMMARY OF THE INVENTION

It is, in general, an object of the invention to provide a new and improved rate sensor, or gyroscope, which is relatively immune to external vibration and acceleration.

Another object of the invention is to provide a rate sensor, or gyroscope, of the above character which overcomes the limitations and disadvantages of rate sensors, or gyroscopes, heretofore provided.

These and other objects are achieved in accordance with the invention by providing a micromachined gyroscope having a pair of masses disposed generally in a plane and driven for out-of-plane torsional oscillation about a pair of drive axes in the plane, an input axis perpendicular to the drive axes, sense axes perpendicular to the drive axes and the input axis, means mounting the masses for in-plane torsional movement about the sense axes in response to Coriolis forces produced by rotation of the masses about the input axis, a link connecting the two masses together for movement of equal amplitude and opposite phase both about the drive axes and about the sense axes, transducers having input electrodes constrained for linear in-plane movement relative to stationary electrodes, and link beams interconnecting the masses and the input electrodes so that torsional movement of the masses about the sense axes produces changes in capacitance between the input electrodes and the stationary electrodes.

### BRIEF DESCRIPTION OF THE DRAWINGS

FIG. 1 is a top plan view of one embodiment of a a micromachined rate sensor, or gyroscope, according to the invention.

FIGS. 2 is an isometric operational view of the embodiment of FIG. 1 illustrating, in exaggerated form, movement of the proof masses in the drive mode.

FIGS. 3 is an isometric operational view of the moving structure in the embodiment of FIG. 1 illustrating, in exaggerated form, movement of the proof masses and transducers in the sense mode.

FIG. 4 is a block diagram of the embodiment of FIG. 1 with double common mode rejection circuitry.

FIG. 5 is a fragmentary vertical sectional view of a micromachined angular rate sensor, or gyroscope, according to the invention.

FIG. 6 is a top plan view of another embodiment of micromachined rate sensor, or gyroscope, according to the invention.

FIGS. 7 is an isometric operational view of the embodiment of FIG. 6 illustrating, in exaggerated form, movement of the proof masses in the drive mode.

FIGS. 8 is an operational top plan view of the moving structure in the embodiment of FIG. 6 illustrating movement of the proof masses and transducers in the sense mode.

FIG. 9 is a top plan view of another embodiment of a micromachined rate sensor, or gyroscope, according to the invention.

FIGS. 10 is an isometric operational view of the embodiment of FIG. 9 illustrating, in exaggerated form, movement of the proof masses in the drive mode.

FIGS. 11 is an operational top plan view of the embodiment of FIG. 9 illustrating movement of the proof masses and transducers in the sense mode.

### DETAILED DESCRIPTION

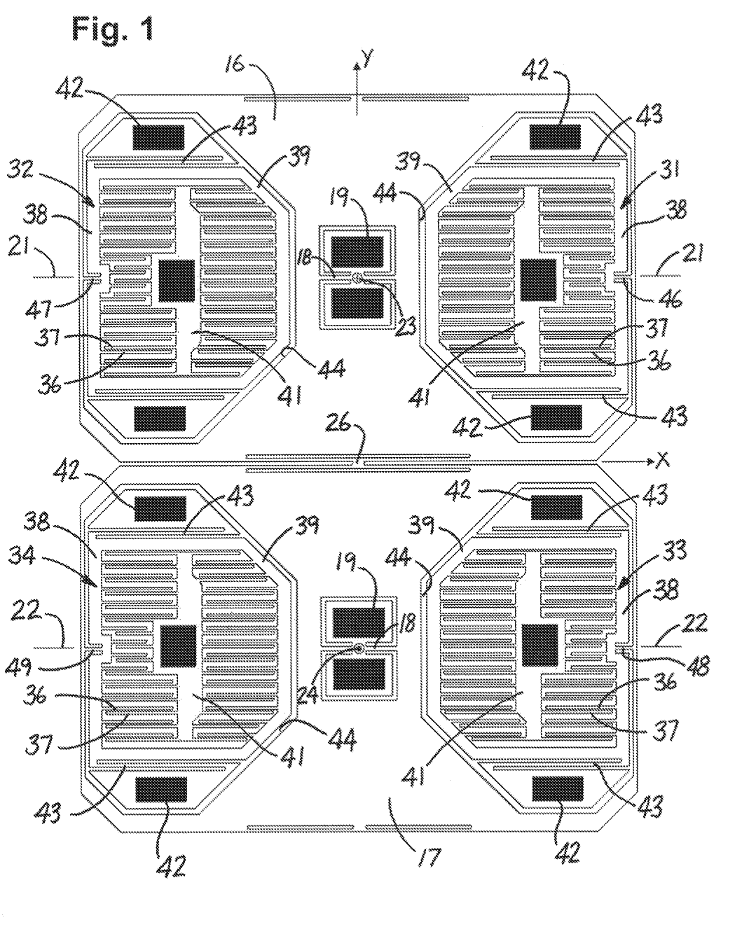

As illustrated in FIG. 1, the rate sensor or gyroscope has a pair of generally planar, rectangular proof masses 16, 17 which are disposed side-by-side and lie in an x, y reference plane when the device is at rest. The proof masses are suspended above a substrate by beams 18 which extend between anchors 19 and the masses. The anchors are disposed centrally of the masses and affixed to the substrate. The beams extend in the x-direction and constrain the masses for out-of-plane torsional rotation about drive axes 21, 22 parallel to the x-axis and for in-plane torsional rotation about sense axes 23, 24 which are located at the centers of the masses and perpendicular to the x, y plane.

The midpoints of the adjacent sides of the masses are connected together by a rigid coupling link 26 which permits anti-phase rotation of the two masses about the drive and sense axes while preventing in-phase rotation about those axes. The two masses are thus constrained so that the movement of the two masses both about drive axes and about sense axes is precisely equal in magnitude and opposite in phase. Thus, even in the presence of mechanical imbalances, the two masses are strictly constrained to oscillate in an anti-phase manner and with the exact same amplitude in both the drive mode and the sense mode.

Torsional movement of the masses about sense axes 23, 24 is monitored by transducers 31-34. Each of the transducers has a plurality of spaced apart, parallel input electrodes or plates 36 and a corresponding number of stationary electrodes or plates 37. The input plates are mounted on a shuttle 38 having a peripheral frame 39, with the input plates extending toward each other from opposite sides of the frame in a direction parallel to the x-axis. The stationary plates are mounted on an anchor or stator 41 within the frame and interleaved with the input plates.

The shuttles are suspended from anchors 42 by linear flexures or beams 43 which extend in a direction parallel to the plates and are flexible only in a direction perpendicular to the plates. In the embodiment illustrated, the beams extend in a direction parallel to the x-axis, and the shuttles are constrained for linear in-plane movement in a direction parallel to the y-axis, with motion in all other directions being suppressed.

The transducers are mounted in openings 44 in the masses, with transducers 31, 32 on opposite sides of proof mass 16 and transducers 33, 34 on opposite sides of proof mass 17. Transducers 31, 33 are positioned on one side of the two masses, and transducers 32, 34 are on the other side. As best seen in FIG. 1, the input plates and the stationary plates of the four transducers are arranged in a symmetrical manner with respect to the x- and y-axes. In the transducers associated with the mass above the x-axis (mass 16 and transducers 31, 32), the input plates 36 are positioned below the stationary plates 37, and in the transducers associated with the mass below the x-axis (mass 17 and transducers 33, 34), input plates 36 are positioned above stationary plates 37. Thus, the input plates of the two transducers on either of the x-axis (transducers 31, 32 and transducers 33, 34) are on the same side of the stationary plates, whereas the input plates of the two transducers on either side of the y-axis (transducers 31, 33 and transducers 32, 34) are on opposite sides of the stationary plates.

The torsional movement of the proof masses about the sense axes is converted to linear movement of the input plates of the transducers by link beams 46, 47 which interconnect mass 16 and the shuttle frames of transducers 31, 32, and by link beams 48, 49 which interconnect mass 17 and the shuttle frames of transducers 33, 34. The connections to the masses are made on the outer sides of the transducers, i.e. the sides opposite anchors 19, near the outer edges of the masses. With the connections to the masses being made away from the sense axes, the movement of the transducer plates for a given movement about the sense axes is amplified by the radius of connection, i.e. the distance between the sense axes and the points of connection to the masses.

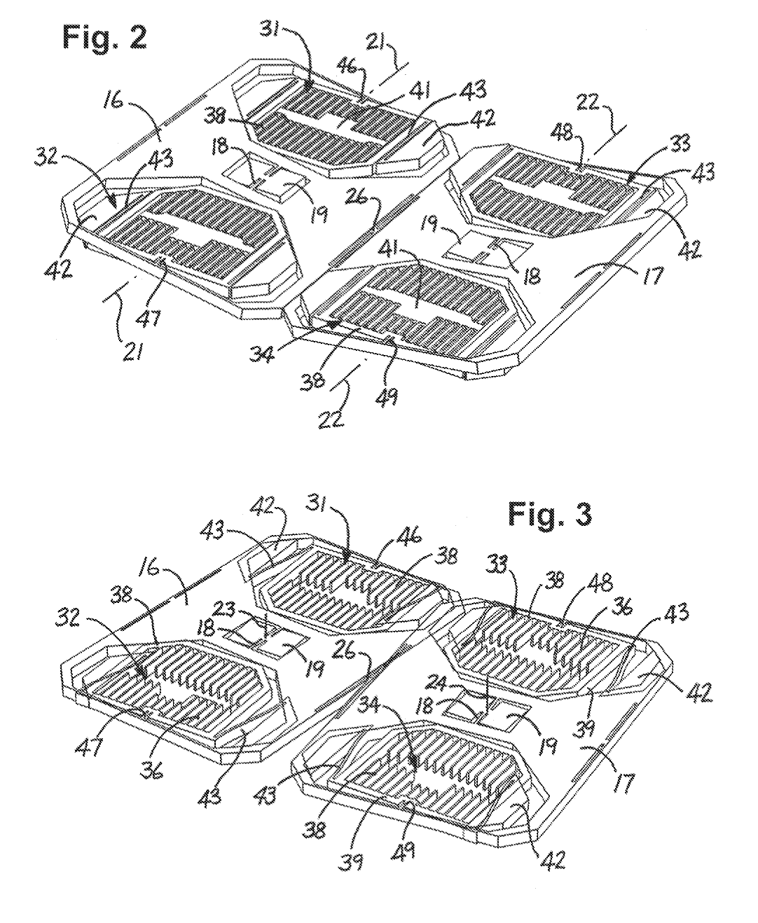

In the drive mode, proof masses 16, 17 are driven to oscillate in an anti-phase manner about drive axes 21, 22, as illustrated in FIG. 2. Since suspension beams 18 are connected directly to anchors 19, the majority of the drive oscillator reaction forces occur at the anchors. This minimizes the forces transferred to the sense shuttles due to the drive oscillation. Thus, the sense shuttles are very well isolated from the drive motion, which minimizes quadrature error and bias due to parasitic sense motion.

With rigid coupling link 26 joining the proof masses together, the two masses are strictly constrained to oscillate in anti-phase manner with the exact same amplitude in the drive mode. This ensures that the angular drive momentum is perfectly balanced and that the device does not inject any vibration energy into the substrate. The rigid link also eliminates undesired parasitic resonant modes that could interfere with the drive mode.

In the sense mode, Coriolis forces produced by the combination of the drive oscillations and rotation of the proof masses about the y-axis cause the masses to move torsionally, or rotate, about sense axes 23, 24. Since the drive oscillations of the two masses are in opposite directions, the Coriolis moments induced in the two masses are also in opposite directions, and an anti-phase torsional oscillation mode is excited, as shown in FIG. 3.

The torsional sense mode response of each proof mass is converted to a linear motion of the shuttles in the two transducers connected to it. Since the shuttles are on opposite sides of the mass, the motions of the two shuttles are in opposite directions and exactly out of phase with each other, and with the shuttles being connected to the masses at a maximum distance from the sense axes, the sense mode response is mechanically amplified, while maintaining the balanced torsional sense operation.

The rigid link strictly constrains the sense mode response of the two proof masses to be perfectly anti-phase. Thus, the two shuttles on each side of the masses move in opposite directions, out of phase with the shuttles on the other side of the masses, and with exactly the same amplitude.

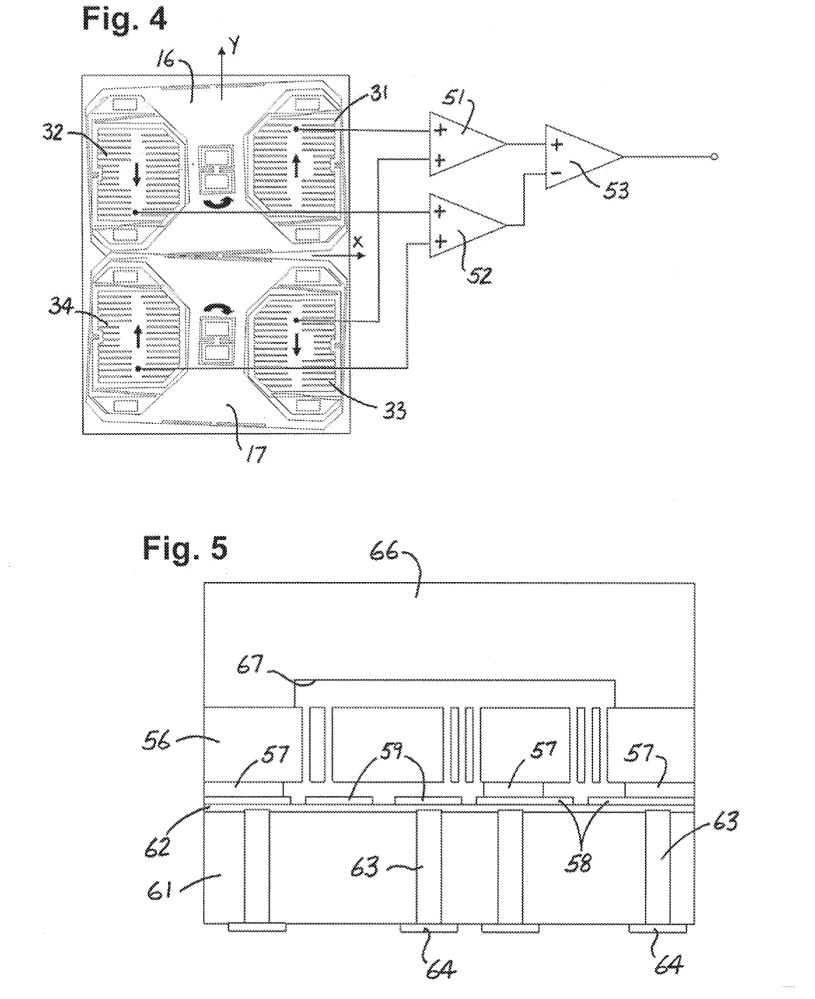

For example, in FIG. 4, as the proof mass 16 rotates counter-clockwise, proof mass 17 rotates clockwise due to the rigid link between them. The counter-clockwise motion of proof mass 16 causes the shuttle in transducer 31 to move in an upward direction away from the x-axis and the shuttle in transducer 32 to move in a downward direction toward the x-axis. Similarly, the clockwise motion of proof mass 17 causes the shuttle in transducer 33 to move in a downward direction away from the x-axis and the shuttle in transducer 34 to move in an upward direction toward the x-axis.

With the transducer plates arranged symmetrically and input plates 36 on the side of stationary plates 37 closer to the x-axis in all four of the transducers, movement of a shuttle away from the x-axis causes the capacitance between the plates to change in one direction, and movement toward the axis causes the capacitance to change in the opposite direction. Thus, the capacitances of transducers 31, 33 change in one direction, and the capacitances of transducers 32, 34 change in the other direction.

Means is provided for detecting a total change in the capacitances of the transducers in accordance with the relationship:

ΔC=(C31+C33)−(C32+C34),

where C31, C32, C33, and C34 are the capacitances of transducers 31, 32, 33, and 34, respectively. As illustrated in FIG. 4, signals corresponding to C31 and C33 are applied to the inputs of a first adder 51 which produces an output signal corresponding to C31+C33, and signals corresponding to C32 and C34 are applied to the inputs of a second adder 52 which produces an output signal corresponding to C32+C34. The output signal from adder 51 is applied to the positive input of a subtraction circuit 53, and the output signal from adder 52 is applied to the negative input of the subtraction circuit. The output of the subtraction circuit is thus a signal corresponding to (C31+C33)−(C32+C34). This arrangement provides a double common-mode rejection which greatly improves the immunity of the rate sensor or gyroscope to external vibration.

As illustrated in FIG. 5, the moving parts of the rate sensor, e.g. the proof masses, shuttles, and beams, are formed in a device layer 56 of a material such as single-crystal silicon, polysilicon, metal, or other conductive material) by etching vertical trenches all the way through the layer using deep-reactive-ion-etching. The device layer rests on anchor posts 57, which provide electrical and mechanical connection from interconnects 58 to the device layer. Out-of-plane drive electrodes 59 are located beneath the device layer and separated from it by the thickness or height of the anchor posts. The interconnects and drive electrodes are formed in a conductive layer which is separated from substrate 61 by an insulative layer 62 that provides electrical isolation for the traces. Interconnects 58 and conductive vias 63 provide electrical connections from the device layer and drive electrodes to bonding pads 64 on the under side of the substrate.

The device is preferably packaged for operation in vacuum to minimize air damping and thereby enhance the mechanical response amplitude of the gyroscope. Vacuum packaging can be done either at the die level or at the wafer level. In the embodiment illustrated, it is done at the wafer level with a bonding cap or wafer 66. Wafer level packaging has many advantages, especially from a cost standpoint, since a large number of devices can be vacuum packaged at the same time. The bonding cap has cavities 67 etched into it, and it can be bonded to the device wafer by any suitable wafer bonding method that provides a hermetic seal. If desired, the electrical connections can be routed outside the cavity through the cap layer, rather than the substrate, using through-wafer vias. The outer ends of the vias can be solder bumped to provide a ball grid array package or connected to bonding pads similar to pads 64 for wirebonding.

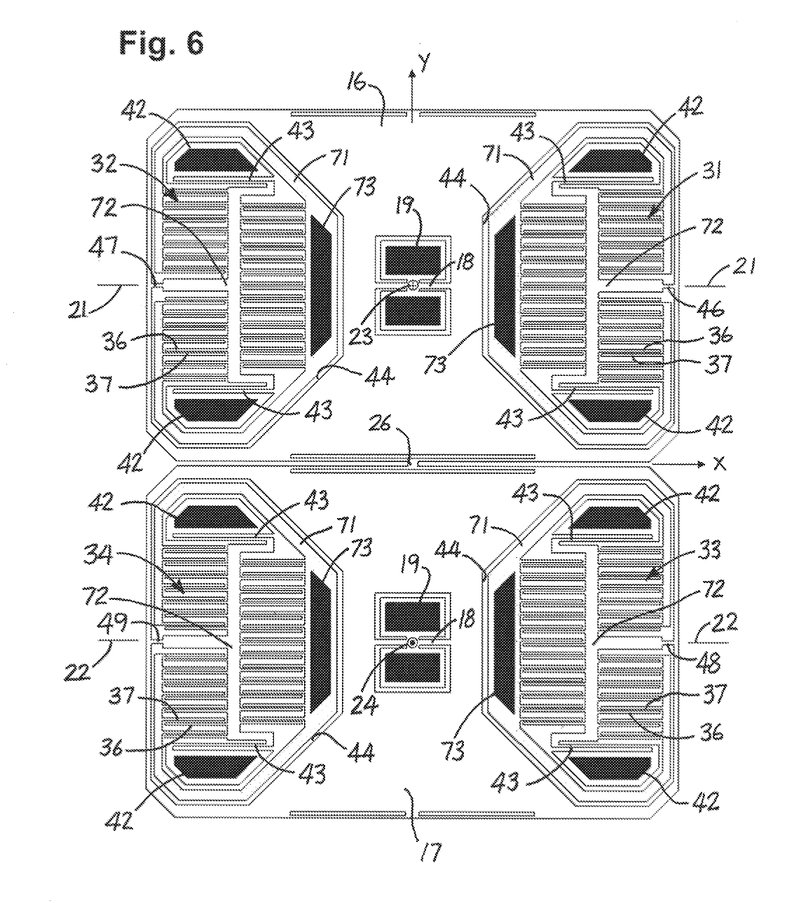

The embodiment of FIG. 6 is similar to the embodiment of FIG. 1 except for the structure of sense transducers 31-34. In this embodiment, the stators 71 on which stationary plates 37 are mounted are in the form of peripheral frames, and the shuttles 72 which carry input plates 36 are positioned within the frames. The stator frames are mounted on anchors 73 positioned toward the inner sides of the transducers, and the link beams 48, 49 that connect the masses to the shuttles are connected to the masses on the outer sides of the transducers, i.e. the sides opposite from the sense axes 23, 24. As in the embodiment of FIG. 1, the shuttles are suspended from anchors 42 by linear flexures or beams 43 which constrain the shuttles for linear in-plane movement in a direction parallel to the input, or y-, axis.

This embodiment also differs in that the input plates 36 of transducers 31, 32 are positioned above the stationary plates 37, and the input plates of transducers 33, 34 are positioned below the stationary plates. Thus, movement of the shuttles in a downward direction produces an increase in the capacitance of transducers 31, 32 and a decrease in the capacitance of transducers 33, 34. Likewise, upward movement of the shuttles decreases the capacitance of transducers 31, 32 and increases the capacitance of capacitors 33, 34.

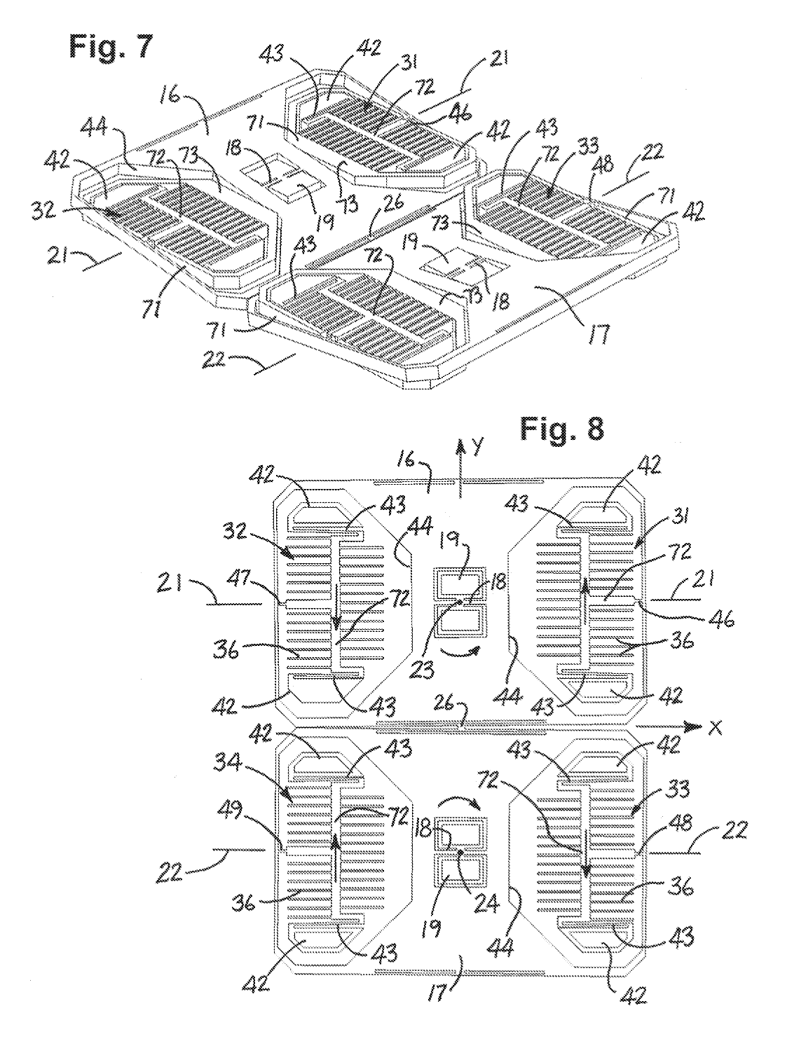

Operation of the embodiment of FIG. 6 is similar to the operation of the embodiment of FIG. 1. In the drive mode, the two masses oscillate about the drive axes in an anti-phase manner with exactly the same amplitudes, as shown in FIG. 7. In the sense mode, the torsional movement of the two masses about the sense axes is likewise exactly out of phase and equal in amplitude, with the shuttles in the transducers on opposite sides of the masses and on the same sides of the masses moving in opposite directions, as shown in FIG. 8. In this embodiment, however, the mass of the shuttles is minimized, which reduces the sense mode moment of inertia, and that improves the scale factor of the rate sensor or gyroscope.

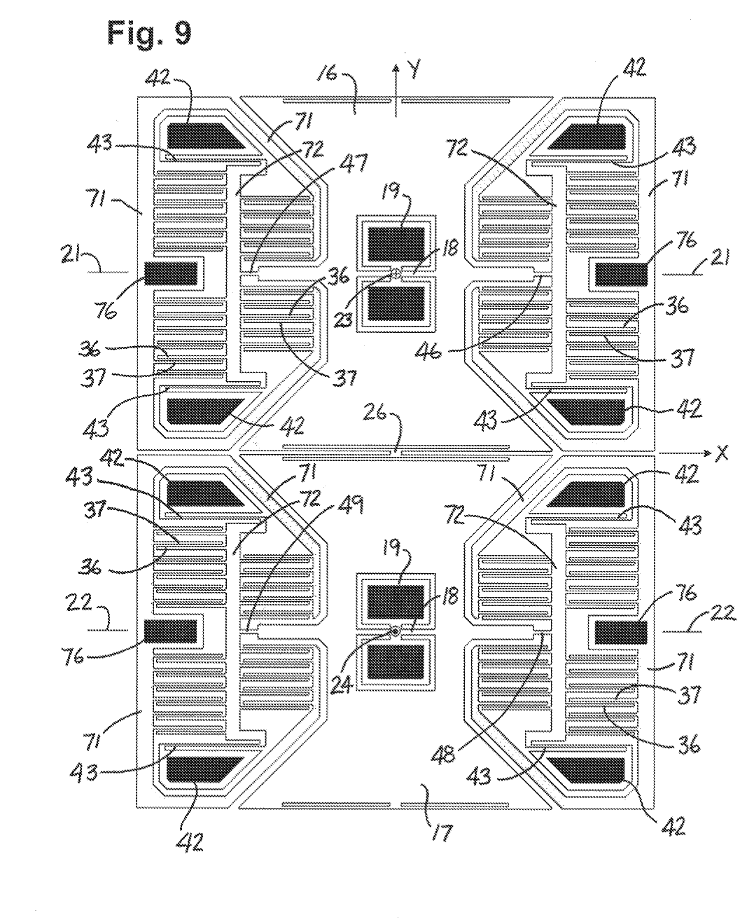

The embodiment of FIG. 9 is similar to the embodiment of FIG. 6, with transducer shuttles 72 once again being mounted within stator frames 71. In this embodiment, however, the anchors 76 on which the stator frames are mounted are positioned toward the outer sides of the transducers, and the link beams 48, 49 that interconnect the masses and the shuttles are connected to the masses on the inner sides of the transducers, near the sense axes. Unlike the first two embodiments, the masses do not wrap around the transducers, and even though the radius of connection and hence movement of the shuttles are both smaller, the moment of inertia of the proof masses in the sense mode is significantly lower without the external connecting structure, which improves scale factor. In addition, the simplified structure of the masses facilitates downsizing of the device.

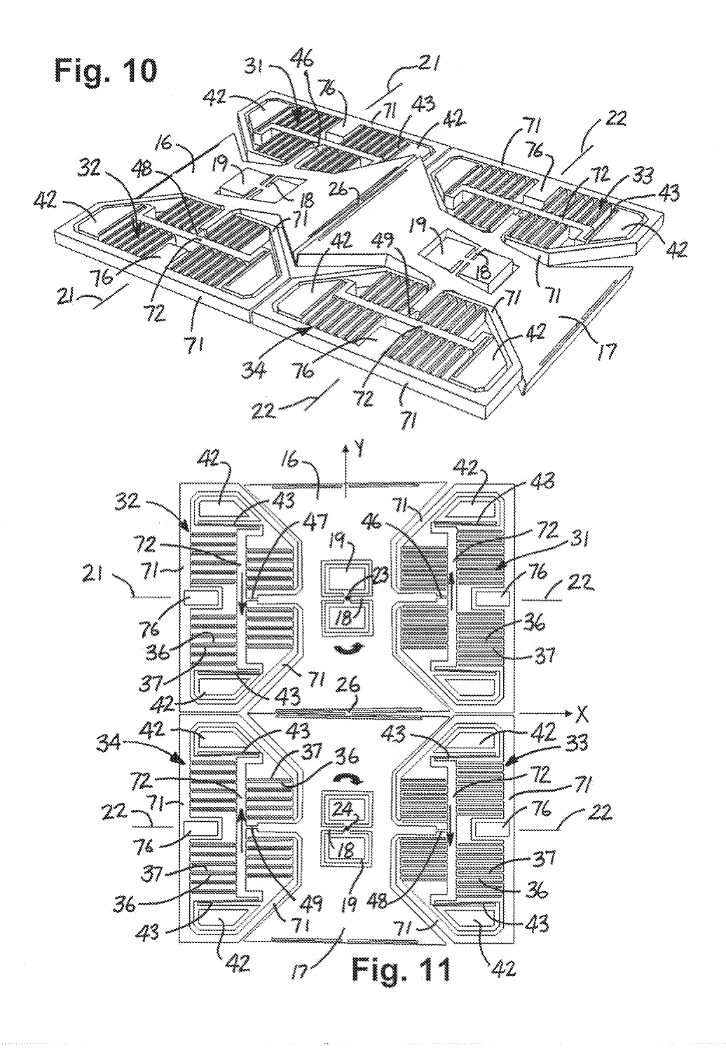

As in the other embodiments, the oscillation of the two masses in the drive mode is precisely out of phase and equal in amplitude, as illustrated in FIG. 10, and the sense mode response of the two masses is likewise precisely out of phase and equal in amplitude, as shown in FIG. 11. As can be seen in that figure, with the counter-clockwise rotation of mass 16 and the clockwise rotation of mass 17, the plates of transducers 31, 33 have moved farther apart, decreasing the capacitance of those transducers, and the plates of transducers 32, 33 have moved closer together, increasing the capacitance of those transducers.

The invention has a number of important features and advantages. It provides a balanced torsional mechanical system, which minimizes the mechanical response to external acceleration inputs, while converting the torsional sense motion into anti-phase linear translation to amplify Coriolis response and cancel out common-mode response.

It is apparent from the foregoing that a new and improved angular rate sensor, or gyroscope, has been provided. While only certain presently preferred embodiments have been described in detail, as will be apparent to those familiar with the art, certain changes and modifications can be made without departing from the scope of the invention as defined by the following claims.

1. A micromachined gyroscope, comprising: a pair of masses disposed generally in a plane and driven for out-of-plane torsional oscillation about a pair of drive axes in the plane, an input axis perpendicular to the drive axes, sense axes perpendicular to the drive axes and the input axis, means mounting the masses for in-plane torsional movement about the sense axes in response to Coriolis forces produced by rotation of the masses about the input axis, a link connecting the two masses together for movement of equal amplitude and opposite phase both about the drive axes and about the sense axes, transducers having input electrodes constrained for linear in-plane movement relative to stationary electrodes, and link beams interconnecting the masses and the input electrodes so that torsional movement of the masses about the sense axes produces changes in capacitance between the input electrodes and the stationary electrodes.

2. The micromachined gyroscope of claim 1 wherein the transducers are positioned on opposite sides of each of the two masses and arranged such that the capacitances of the transducers on opposite sides of each mass change in an anti-phase manner and the capacitances of the transducers on the same sides of the two masses change in an in-phase manner.

3. The micromachined gyroscope of claim 1 wherein the masses are suspended from anchors disposed centrally of the masses, the transducers are located on opposite sides of the anchors, and the link beams are connected to the masses on sides of transducers farthest from the anchors.

4. The micromachined gyroscope of claim 1 wherein the masses are suspended from anchors disposed centrally of the masses, the transducers are located on opposite sides of the anchors, and the link beams are connected to the masses on sides of transducers closest to the anchors.

5. The micromachined gyroscope of claim 1 wherein the transducers have shuttles on which the input electrodes are mounted, with the link beams being connected to the shuttles and the shuttles being constrained for in-plane linear movement.

6. The micromachined gyroscope of claim 5 wherein the electrodes are in the form of generally planar, parallel plates, and the shuttles are suspended by beams which extend in a direction parallel to the plates and are flexible in a direction perpendicular to the plates.

7. The micromachined gyroscope of claim 6 wherein the shuttles are in the form of frames, the input electrode plates extend toward each other from opposite sides of the frames, and the stationary electrodes are in the form of spaced apart parallel plates which are mounted on anchors within the frames and interleaved with the input electrode plates.

8. The micromachined gyroscope of claim 6 wherein the stationary electrodes are in the form of spaced apart parallel plates which are mounted on stationary frames and extend toward each other from opposite sides of the frames, and the shuttles are positioned within the frames with the input electrode plates extending outwardly from the shuttles and being interleaved with the stationary electrode plates.

9. The micromachined gyroscope of claim 1 wherein transducers are positioned on opposite sides of each of the masses, with the transducers on one side having input electrodes on opposite sides of stationary electrodes and the transducers on the same sides of the masses having input electrodes on the same sides of stationary electrodes so that the capacitances of both transducers on the one side change in the same direction and the capacitances of the transducers on the same sides change in opposite directions in response to anti-phase torsional movement of the masses about the sense axes.

10. A micromachined gyroscope, comprising: first and second masses disposed side-by-side in a plane, beams suspending the masses from anchors located centrally of the masses for torsional out-of-plane movement about a pair of drive axes in the plane and for torsional in-plane movement about sense axes perpendicular to the plane, means connecting the two masses together for movement of equal amplitude and opposite phase both about the drive axes and about the sense axes, with Coriolis forces produced by rotation of the masses about an input axis producing torsional movement of the masses about the sense axes, first and second transducers positioned on opposite sides of the first mass, third and fourth transducers positioned on opposite sides of the second mass, link beams interconnecting the masses and the transducers so that torsional movement of the masses about the sense axes produces changes in capacitance in the transducers corresponding to rotation of the masses about the input axis.

11. The micromachined gyroscope of claim 10 wherein the capacitances of the first and third transducers change in one direction and the capacitances of the second and fourth transducers change in an opposite direction in response to anti-phase movement of the masses about the sense axes.

12. The micromachined gyroscope of claim 11 including means for detecting a total change in the capacitances of the transducers in accordance with the relationship:
ΔC=(C1+C3)−(C2+C4),
where C1 and C3 are the capacitances of the first and third transducers and C2 and C4 are the capacitances of the second and fourth transducers.

13. A micromachined gyroscope, comprising: a pair of masses disposed side-by-side in a plane, beams suspending the masses from anchors located centrally of the masses for torsional out-of-plane movement about a pair of drive axes in the plane and for torsional in-plane movement about sense axes perpendicular to the plane, means connecting the two masses together for movement of equal amplitude and opposite phase both about the drive axes and about the sense axes, with Coriolis forces produced by rotation of the masses about an input axis producing torsional movement of the masses about the sense axes, transducers positioned on opposite sides of each of the masses having input plates that extend toward each other from opposite sides of peripheral shuttle frames and stationary plates disposed within the frames and interleaved with the input plates, flexible beams constraining the shuttle frames for linear in-plane movement in directions perpendicular to the plates, and link beams interconnecting the masses and the shuttle frames so that torsional movement of the masses about the sense axes produces changes in capacitance between the input plates and the stationary plates.

14. The micromachined gyroscope of claim 13 wherein the link beams are connected to the masses on sides of the shuttle frames opposite the anchors.

15. The micromachined gyroscope of claim 13 wherein the capacitances of the transducers on opposite sides of each mass change in an anti-phase manner and the capacitances of the transducers on the same sides of the two masses change in an in-phase manner.

16. A micromachined gyroscope, comprising: a pair of masses disposed side-by-side in a plane, beams suspending the masses from anchors located centrally of the masses for torsional out-of-plane movement about a pair of drive axes in the plane and for torsional in-plane movement about sense axes perpendicular to the plane, means connecting the two masses together for movement of equal amplitude and opposite phase both about the drive axes and about the sense axes, with Coriolis forces produced by rotation of the masses about an input axis producing torsional movement of the masses about the sense axes, transducers positioned on opposite sides of each of the masses having stationary plates extending toward each other from opposite sides of peripheral frames and input plates which are mounted on shuttles within the frames and interleaved with the stationary plates, flexible beams constraining the shuttles for linear in-plane movement in directions perpendicular to the plates, and link beams interconnecting the masses and the shuttles so that torsional movement of the masses about the sense axes produces changes in capacitance between the input plates and the stationary plates.

17. The micromachined gyroscope of claim 16 wherein the link beams are connected to the masses on the sides of transducers farthest from the anchors.

18. The micromachined gyroscope of claim 16 wherein the link beams are connected to the masses on the sides of transducers closest to the anchors.

19. The micromachined gyroscope of claim 16 wherein the capacitances of the transducers on opposite sides of each mass change in an anti-phase manner and the capacitances of the transducers on the same sides of the two masses change in an in-phase manner.
